(19) United States
(12) Patent Application Publication
(10) Pub. No.: US 2012/0040314 A1
(43) Pub. Date: Feb. 16, 2012

(54) Body Ornamentation Design, Customization, and Management System

(75) Inventor: Louis Rubino, JR., Saint James, NY (US)

(73) Assignee: ARTISTIC TATTOOING, INC., Saint James, NY (US)

(21) Appl. No.: 13/208,876

(22) Filed: Aug. 12, 2011

Related U.S. Application Data
(60) Provisional application No. 61/372,980, filed on Aug. 12, 2010.

(51) Int. Cl. G09B 11/00; G06Q 30/00

(52) U.S. Cl. 434/81; 705/26.5

(57) ABSTRACT

A body ornamentation design, customization and management system, which may include any combination of a Customer Profile Module, a Tattoo Design Module, a Tattoo Stencil Creation Module, an Artist Portfolio Module, an Administration Module, an Informational Document Module, an FAQ Module, an Advertising Module, a Body Jewelry Module and Legal Module, is provided. The body ornamentation design, customization and management system provides an efficient and effective system for the management of a body ornamentation design business (such as a tattoo shop), as well as an efficient and effective system for allowing a customer to select a body ornamentation design, and for having the body ornamentation design applied to the customer's body. A documentation system is also provided for collecting, organizing and maintaining records relating to the business of a body ornamentation business (such as a tattoo shop).

### CLAIM OF PRIORITY

This application claims the benefit of U.S. Provisional Application No. 61/372,980 filed Aug. 12, 2010, the entire contents of which are incorporated by reference as if fully set forth herein.

### FIELD OF THE INVENTION

The present invention is directed to the field of body ornamentation designs such as tattooing and body piercing, and more specifically, to a system for designing, customizing and managing body ornamentation designs, as well as the management of businesses that provide body ornamentation designs, such as tattoo shops and body piercing shops.

### BACKGROUND

Generally, a tattoo or body piercing may be considered a form of body ornamentation, and a particular tattoo design or piece of body jewelry may be considered a form of body ornamentation as well. In the body ornamentation designs such as the tattoo field, there is currently no efficient and effective way to track tattoo customers, tattoo designs, tattoo artist galleries, and other necessary processes and functions of a body ornamentation business or “parlor” (or “shop,” and also referred to as a “tattoo shop,” it being appreciated that such tattoo shops also perform, for example, body piercings).

Moreover, there is no simple, effective, efficient or “modern” way for a customer to select and manage their body ornamentation designs. The field of tattooing often involves the selection and design of a tattoo for a tattoo customer. That selection process has, historically, been conducted by “hard copy” or printed images. The known process has various drawbacks, such as taking a long time, and being tedious. Also, customers generally do not have an efficient way to track, save or manage body ornamentation designs they have reviewed or selected.

Similarly, in the related field of body piercing, there is currently no efficient and effective way to track body piercing locations or sites, body piercing jewelry designs, body piercing photograph galleries, and other necessary processed and functions of a tattoo shop that also offers body piercing services.

In addition, historically, tattoo shops have not used the latest electronic and computer technology to enhance and streamline the tattoo experience. Customization is difficult. In addition, a particular customer's records or history with a particular tattoo shop are not easily tracked. Also, it is difficult for tattoo shops to track records relating to a customer's services, payment, history, and other related documents relating to services provided by a shop to a customer. Moreover, documentation relating to the shop's business is often maintained on hard copy, is difficult to retrieve or review, and cannot be easily accessed.

In addition, tattoo and body piercing shops generally have an appearance, look and feel that is dated. Generally, tattoo shops have pictures all over the walls of the tattoo shop showing images of tattoo designs for a customer to review or select. This creates for a cluttered appearance, look and feel.

There exists, therefore, a need for an efficient and effective system for managing a tattoo and body piercing shop, as well as for providing a customer and body ornamentation business with an efficient and effective system for viewing, selecting, and customizing a tattoo or body piercing, and for facilitating the application of the tattoo or body piercing to a person's body. There is also the need for a system that provides for an efficient and effective way to handle the records and documentation that relate to the business of a body ornamentation shop, such as a tattoo or body piercing shop.

### SUMMARY OF THE INVENTION

In one aspect, a body ornamentation design, customization and management system is provided, including at least one computer, the at least one computer comprising software. The software includes a customer profile module, a tattoo design module, a tattoo stencil creation module, and, an administration module. Additional modules and equipment may be provided as described herein.

A method of utilizing a body ornamentation design, customization and management system is also provided. Customer information is obtained via the customer profile module and stored by the customer profile module. A selection of body ornamentation designs (e.g., tattoo designs or body piercing jewelry designs) are presented to the customer via the tattoo design module or a body jewelry module, so that the customer can select a body ornamentation design for application to the person's body. Once selected, the selected body ornamentation design is stored in the customer profile module for that person. The customer profile module is accessed by an administrator (e.g., a person with administrative privileges. In the case of a tattoo design, a stencil is created by the tattoo stencil creation module representing the body ornamentation design, so that the design may be applied to a person's body. The stencil is printed via a printer, and applied to the person's body. Various customer and administrative functions may also be performed using modules of the invention, as described herein.

### DESCRIPTION OF THE DRAWINGS

FIG. 1 is a first representative display screen of a terminal or computer running body ornamentation design and management software according to the present invention, showing the Customer Log-In Screen of the Customer Profile Module.

FIG. 2 is a representative display screen of a terminal or computer running body ornamentation design and management software according to the present invention, showing a Customer Profile Creation Screen of the Customer Profile Module.

FIG. 3 is a representative display screen of a terminal or computer running body ornamentation design and management software according to the present invention, showing a screen of the Tattoo Design Module.

FIG. 4 is a representative display screen of a terminal or computer running body ornamentation design and management software according to the present invention, showing another screen of the Tattoo Design Module, showing the results of a keyword search.

FIG. 5 is a representative display screen of a terminal or computer running body ornamentation design and management software according to the present invention, showing another screen of the Tattoo Design Module, showing a category search, and image thumbnails.

FIG. 6 is a representative display screen of a terminal or computer running body ornamentation design and management software according to the present invention, showing another screen of the Tattoo Design Module, showing a selected tattoo image with draft text.

FIG. 7 is a representative display screen of a terminal or computer running body ornamentation design and management software according to the present invention, showing another screen of the Tattoo Design Module, showing a selected tattoo image with draft text and another font and size selection.

FIG. 8 is a representative display screen of a terminal or computer running body ornamentation design and management software according to the present invention, showing another screen of the Tattoo Design Module, showing a selected tattoo image with draft text is a selected layout.

FIG. 9 is a representative display screen of a terminal or computer running body ornamentation design and management software according to the present invention, showing a screen of the Tattoo Stencil Creation Module, showing a selected tattoo image with text and a tattoo stencil derived from the tattoo image and text.

FIG. 10 is a representative display screen of a terminal or computer running body ornamentation design and management software according to the present invention, showing the print screen of the Tattoo Stencil Creation Module.

FIG. 11 is a representative display screen of a terminal or computer running body ornamentation design and management software according to the present invention, showing the Informational Document Module.

FIG. 12 is a representative display screen of a terminal or computer running body ornamentation design and management software according to the present invention, showing an embodiment of a screen of the Tattoo Design Module with text only.

FIG. 13 is a representative display screen of a terminal or computer running body ornamentation design and management software according to the present invention, showing an Artist Portfolio Module.

FIG. 14 is a representative display screen of a terminal or computer running body ornamentation design and management software according to the present invention, showing a gallery of tattoo designs.

FIG. 15 is a representative display screen of a terminal or computer running body ornamentation design and management software according to the present invention, showing an Administration Screen from the Administration Module.

FIG. 16 is a representative display screen of a terminal or computer running body ornamentation design and management software according to the present invention, showing another Administration Screen from the Administration Module.

FIG. 17 is a representative display screen of a terminal or computer running body ornamentation design and management software according to the present invention, showing another Administration Screen from the Administration Module.

FIG. 18 is a representative display screen of a terminal or computer running body ornamentation design and management software according to the present invention, showing a “Frequently Asked Question”or FAQ Management screen from an FAQ Module of an embodiment of the present invention.

FIG. 19 is a representative display screen of a terminal or computer running body ornamentation design and management software according to the present invention, showing an Advertising Management screen from an Advertising Module.

FIG. 20 is a representative display screen of a terminal or computer running body ornamentation design and management software according to the present invention, showing another Advertising Management screen.

FIG. 21 is a representative display screen of a terminal or computer running body ornamentation design and management software according to the present invention, showing a screen with tattoo design category management from the Tattoo Design Module.

FIG. 22 is a representative display screen of a terminal or computer running body ornamentation design and management software according to the present invention, showing the exportation of a customer mailing list compiled using the present invention.

FIG. 23 is a schematic representation of the various Modules of the software of the present invention.

FIG. 24 is a schematic representation of a network of computers and/or computer terminals running or otherwise incorporating one or more components of the body ornamentation design and management software according to the present invention, as well as peripheral equipment that may be connected to or otherwise in communication with the system.

FIG. 25 shows a representative customer station with display screens, keyboards and a computer mouse, for using the body ornamentation design and management system according to the present invention.

FIG. 26 shows a flow chart of a potential consumer and administrator using the system of the present invention.

FIG. 27 shows is a schematic representation of a network of computers and/or computer terminals provide access to the present invention through the internet.

FIG. 28 shows a diagrammatic representation of the projector system of the present invention.

FIG. 29 shows a diagrammatic representation of interconnected tattoo shops using the present system for updates.

FIG. 30 shows a diagrammatic representation of an artist interacting with and/or utilizing various components of the present invention.

FIG. 31 shows a page from an illustrative form that may be generated by the system of the present invention.

FIG. 32 shows another page from an illustrative form that may be generated by the system of the present invention.

### DESCRIPTION OF INVENTION

The present invention generally comprises a body ornamentation design and management system 10, including software 11 run on one or more computers 12, described in greater detail below. As used herein, the term “tattoo shop” refers to any establishment engaged in the business of displaying, designing, and applying tattoos, and also includes the business of selling and applying body piercings (jewelry). In addition, the phrase “body ornamentation design” can refer to the fields of tattooing and/or body piercing.

It is contemplated that there will be two primary users of the present system 10: (1) a customer 16 (also referred to as a “user” in the context of a user of the system who is also a customer), which refers to any person patronizing a tattoo shop 13 for the purpose of selecting and/or obtaining and/or browsing a tattoo and/or body piercing; and (2) the employees and/or management of a tattoo shop 13 (collectively, an “administrator 34”). In addition, potential customers may simply wish to browse through the system 10 as a “guest,” and such guests are considered “customers” as well.

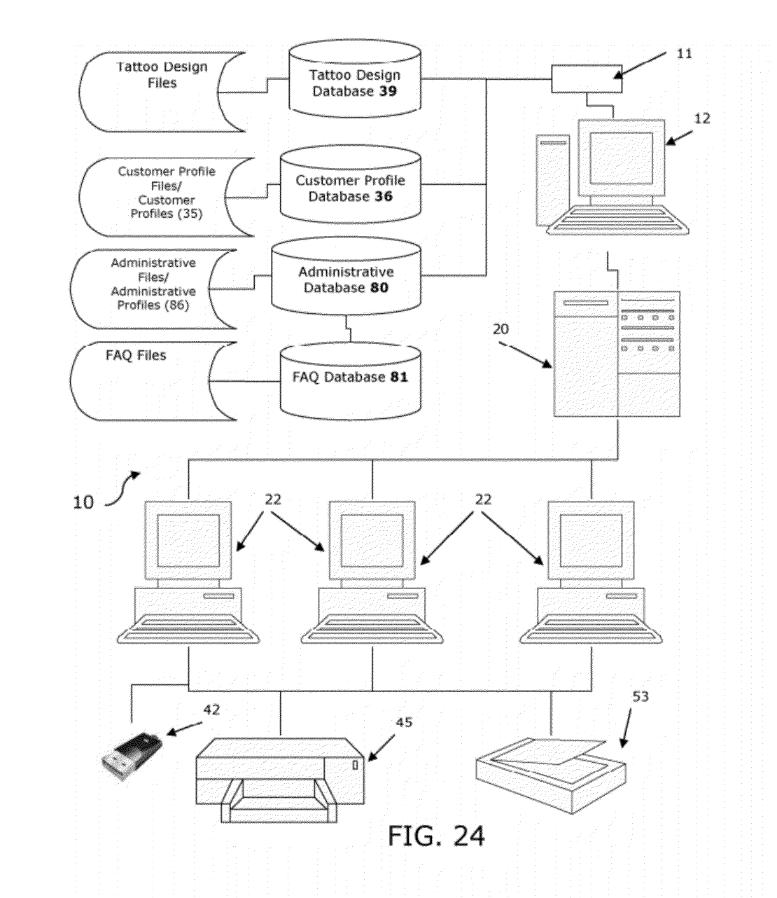

A diagrammatic representation of an embodiment of the system 10 is shown in FIG. 24. The system 10 software 11 for performing some or all of the operations and/or processes and/or functions and/or actions described herein may reside, for example, on a main computer 12 or computer mainframe that may be accessible by tattoo shop, administrator and/or client computers 55 via a server 20. As shown in FIG. 24, the software 11 includes various databases and files for use in performing system 10 actions. The various modules (e.g., modules 24, 25, 26, 27, 28, 29, 30, 31, 32, 79, 85, 200) discussed and described herein comprise software for performing the functions discussed and described herein.

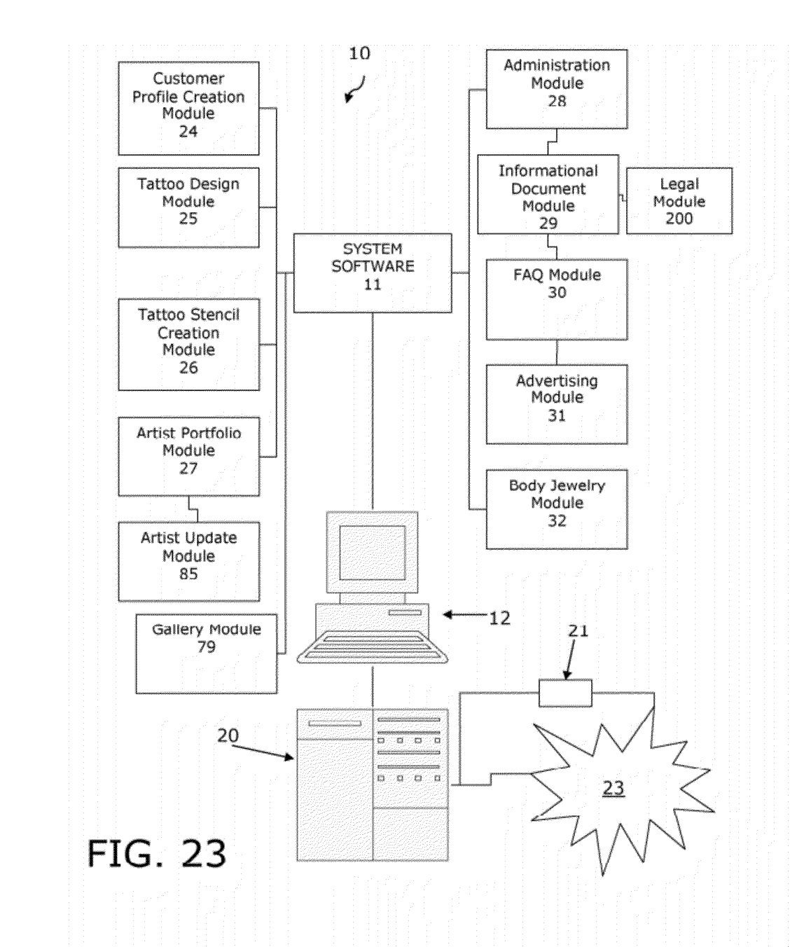

Customers and/or administrators 34 and/or guests preferably access the software 11 of the system 10 through a customer or “client” computer 55. Peripherals such as a stencil printer 45 (preferably, a thermal printer 45 adapted to print usable tattoo stencils 43), and an optional scanner 53 are in communication with the computers 12 and software 11 of the system 10. It is appreciated that any combination of the modules shown in FIG. 23 may be included in a system according to the present invention, and that FIG. 24 only represents some of the components shown in the other Figures, as illustration only.

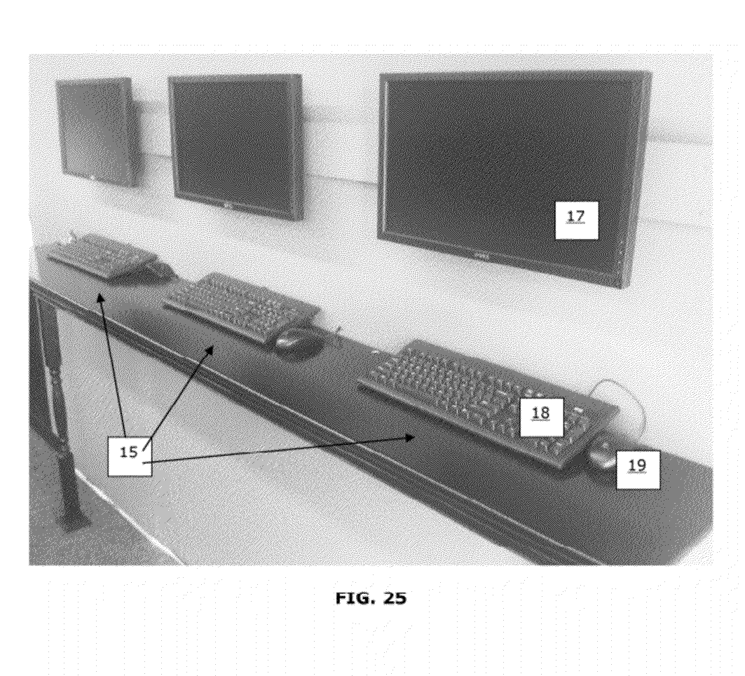

A customer 16 at a tattoo shop 13 having equipment adapted to run the current system 10 may interface and/or communicate with the system 10 through a customer station 15, such as shown in FIG. 25. The customer station 15 may include a monitor 17, a keyboard 18, and a mouse 19 (pointing device). The monitor 17 may be in communication with a server 20 running the software 11 of the system 10 of the present invention. The monitor 17 also may be connected to its own dedicated PC computer 12, or through a “thin client” or “client” 55 computers connected to a server or otherwise networked. The computers of the present system may be connected and in communication such as via a network 23 that may include a hub 21. Any means of interconnecting computers and software so that they are networked may be used. The customer station (or other selected components of the system) also can be equipped with fingerprint or other biometric equipment or scanners to ensure that Client Profiles are protected.

A schematic representation of the various software 11 modules is shown in FIG. 23. The software 11 may comprise, for example, at least the following modules, as well as others described herein: a Customer Profile Module 24; a Tattoo Design Module 25; a Tattoo Stencil Creation Module 26; an Artist Portfolio Module 27; an Administration Module 28; an Informational Document Module 29; an FAQ Module 30, an Advertising Module 31; and a Body Jewelry Module 32. Each module comprises software 11 necessary for performing tasks and/or actions and/or functions and/or processes of the system 10. The software is preferably housed on at least one computer 12, in communication with a server 20, and a network 23.

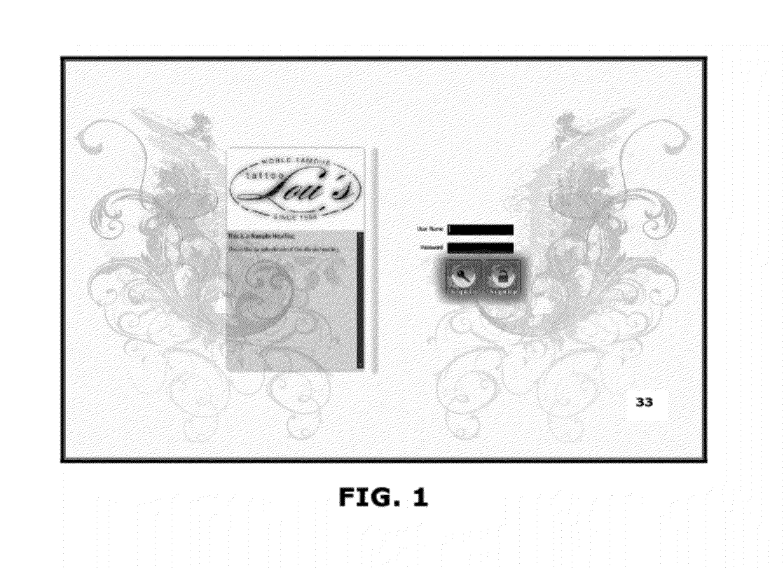

FIG. 1 shows a representative display screen as a Login Screen 33 a customer 16 may encounter when accessing the system 10 of the present invention. The screens shown in illustrative FIGS. 1-22 are shown as having a particular decoration or “skin” that is a special design that may be selected for a particular tattoo shop. It is appreciated that any design or “skin” may be used to create a decorative look, feel and/or theme for a particular tattoo shop using a system of the present invention.

This screen of FIG. 1 relates to the Customer Profile Module 24 of the software 11. The tattoo shop 13 name and/or logo may be displayed on the screen. An administrator 34 (i.e., person with administrative rights to the system) of the system 10 also may be able to insert text under the tattoo shop 13 name and/or logo, such as informational text. As shown in FIG. 1, the opening display or Login Screen 33 includes a space for a customer 16 to enter a user name and password and log into the system 10 (“SignIn”), or to sign up for the system 10 (“SignUp”) by creating a Customer Profile 35.

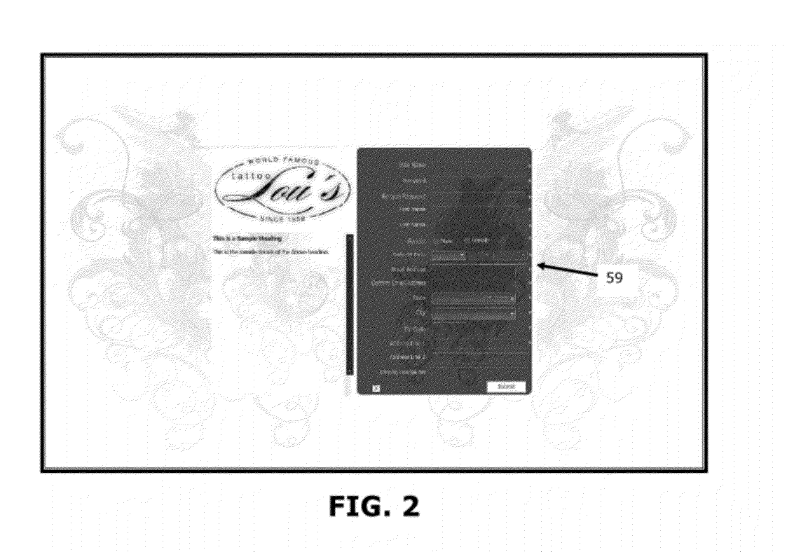

FIG. 2 shows a representative Customer Profile 35 creation screen for use by a customer 16 who wishes to create a Customer Profile 35. The customer 16 can enter demographic information in the spaces of the template 59 or form provided, as shown in FIG. 2, including information such as name, address, sex, date of birth, e-mail contact information, driver's license, etc. The administrator 34 may customize the template/form in order to gather additional information in the Customer Profile 35. The Customer Profile 35 is preferably saved as a file of the software 11, and may be added and/or stored in the Customer Profile Database 36. Customer Profiles 35 may be stored in the Customer Profile Database 36 residing on, for example, a server 20 running software 11 of the present invention.

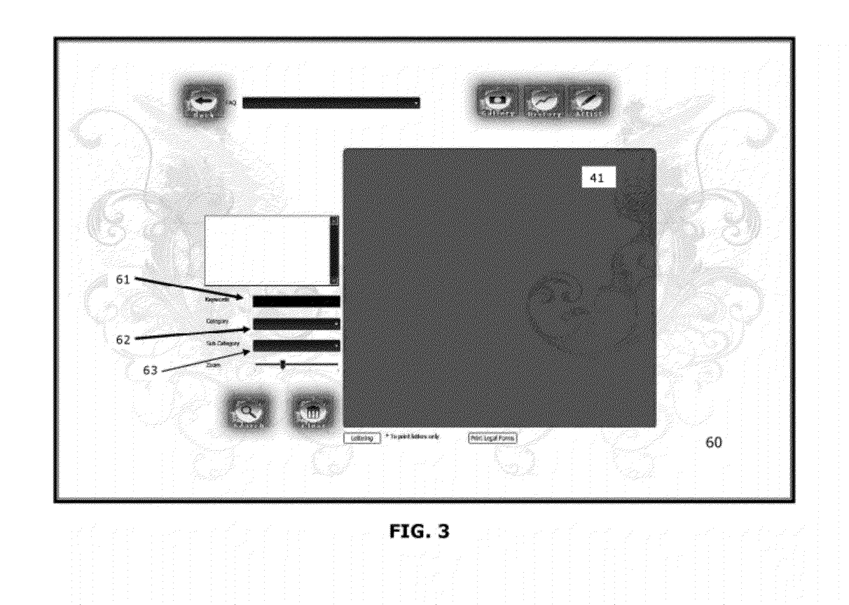

FIGS. 3-9 show representative display screens showing a Tattoo Design Module 25 of the present invention. A “tattoo design” 37 may refer to any graphics, symbols, logos, text, images, illustrations, or other designs that a customer 16 desires as a tattoo. As shown in FIG. 3, a display screen 60 of the Tattoo Design Module 25 provides a customer 16 the opportunity to easily browse a collection of possible tattoo designs 37 (graphic, art, or image) for selection. The collection of images may be stored or otherwise comprised in a Tattoo Design Database 39. The customer 16 is able to search the tattoo shop's 13 Tattoo Design Database 39 by entering keywords in a keyword field 61, as shown by FIG. 3. In addition, a customer 16 can also browse tattoo designs 37 by choosing from a Category 62 and/or Sub-Category 63 drop-down menus.

The Tattoo Design Module 25 preferably includes all tattoo graphics, symbols, logos, text, images, illustrations, or other design files for use by the system 10. Thus, the Tattoo Design Database 39 may be considered a library and/or collection of all potential tattoo designs 37 of any kind accessible and/or used by the system 10. Tattoo designs 37 may be tagged or otherwise associated with certain search or keyword terms, for use by the system 10.

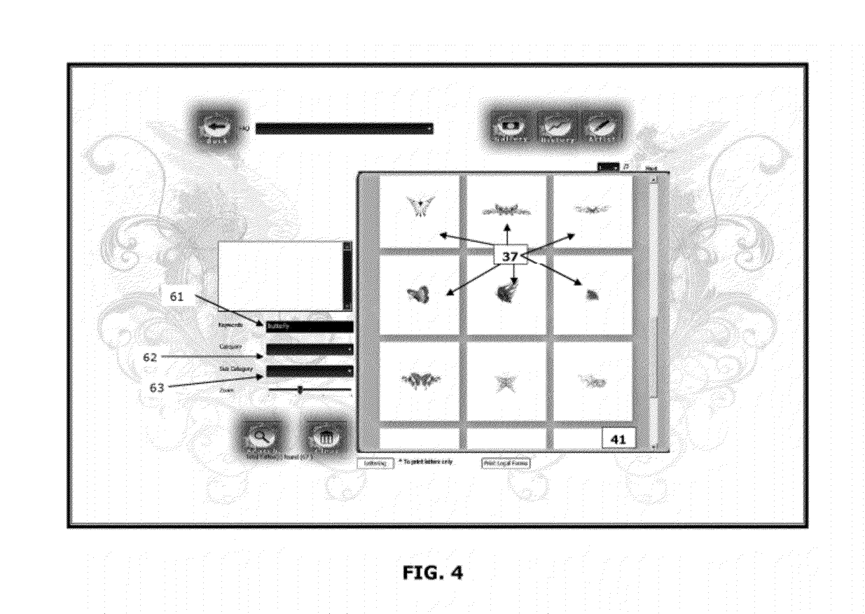

FIG. 4 shows representative results of a keyword search for the term “butterfly.” The software 11 of the Tattoo Design Module 25 searches the Tattoo Design Database 39 and returns results corresponding to any tattoo designs 37 that have been tagged or otherwise associated with the term “butterfly.” As shown in FIG. 4, relevant thumbnail images 40 are displayed in a thumbnail gallery/search results box 41 for review and/or selection by the customer 16. The images shown in the search results frame represent those images tagged or otherwise associated by the system with the search term “butterfly.” The customer 16 is able to scroll through the search results using, for example, scroll bars as shown in FIG. 4.

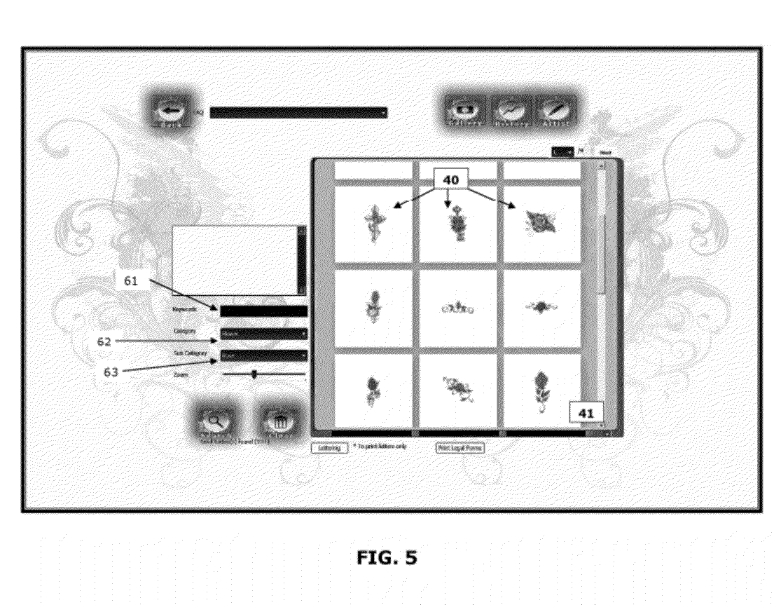

FIG. 5 shows representative results of a “Category” and “Sub Category” tattoo design search. In the example shown in FIG. 5, the Category is “flower,” and the Sub Category is “rose.” The software 11 of the Tattoo Design Module 25 is configured to search the Tattoo Design Database 39, and returns the relevant tattoo designs 37 in the thumbnail gallery/search results box 41.

It is contemplated that tattoo designs 37 may be uploaded by the administrator 34 of the system 10. In addition, the system 10 may be configured so that a customer 16 can bring his/her own tattoo design, such on a portable thumb or flash drive 42, and upload own image, which may be a custom image, to the system 10 for selection and use. This ease of use encourages customization and creativity. In addition, as described below, a customer can save designs to, or associate designs with, their Customer Profile 35.

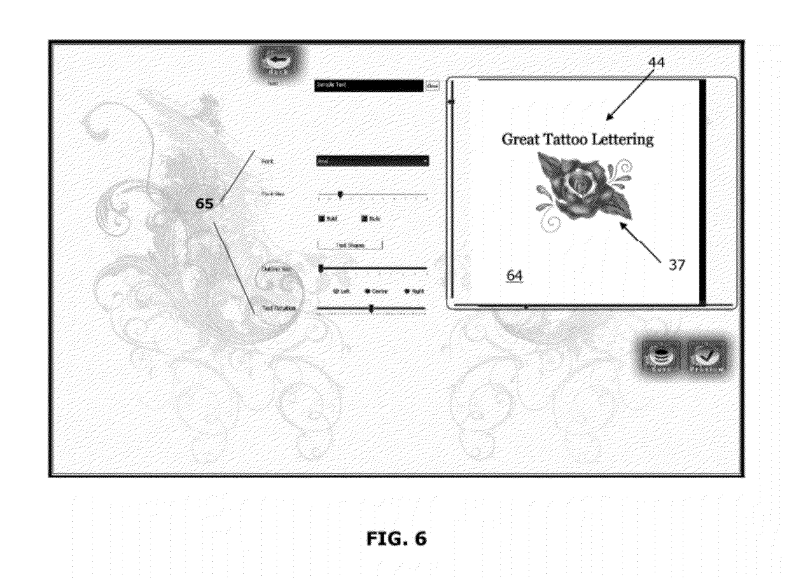

FIG. 6 shows a representative screen of the Tattoo Design Module 25 where a customer 16 has selected a tattoo design (in this case, a rose), and wishes to add text 44 to the proposed tattoo design 37. FIG. 6 shows the proposed tattoo design 37 in a tattoo design editing window 64. The software of the Tattoo Design Module 25 preferably comprises full word processing and graphics program functionality. All functionality of a word processing or graphics program such as, for example, Microsoft Word®, Photoshop®, CorelDraw®, or similar programs, in creating, customizing, and editing text, are preferably included as part of the Tattoo Design Module 25. Various text editing tools 65 can be seen in FIG. 6. Text and/or graphics can be modified, revised or otherwise designed or changed by appearance, color, font, or any other parameter as is known in the relevant art.

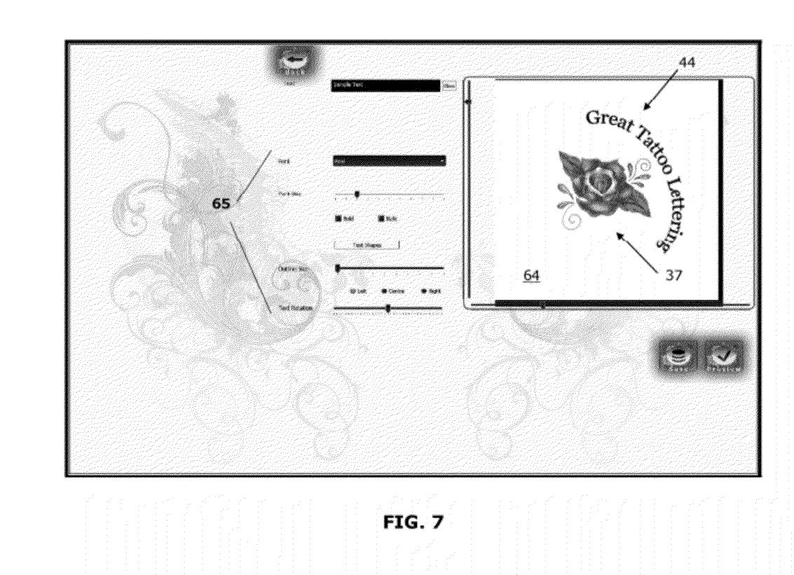

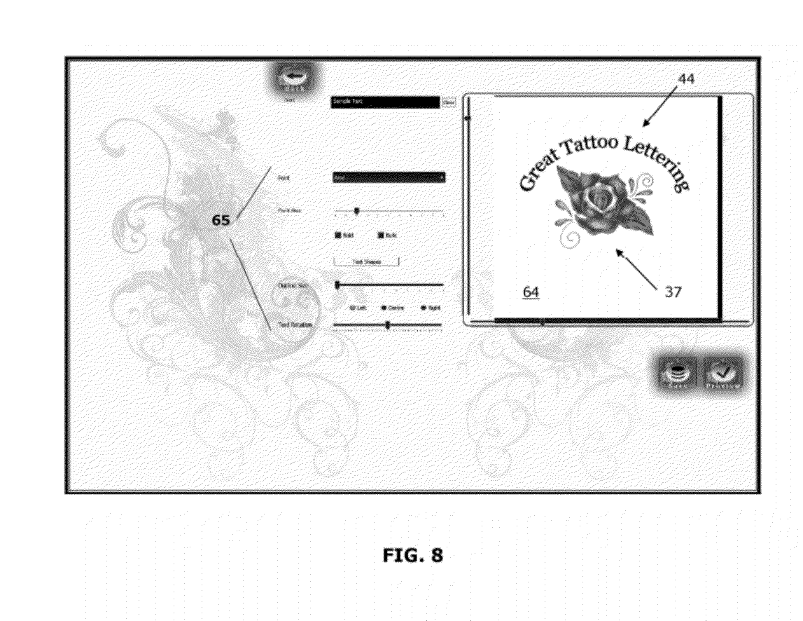

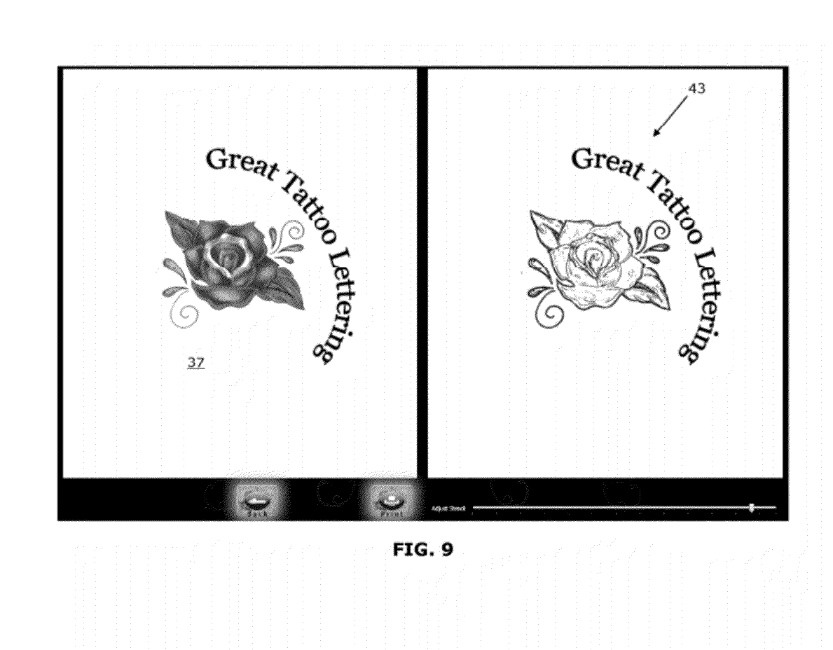

As shown by FIG. 6, for example, a customer 16 can enter text in a text box, and select the font and font size. As additionally shown in FIGS. 7 and 8, the customer 16 can manipulate and customize the text 44, such as by resize the text, wrapping the text in various configurations, or rotating the text. FIGS. 8 and 9 show the illustrative text in different curved configurations, all selected and customized by a customer 16. It is contemplated that any text manipulation that may be accomplished by a word processing or computer 12 graphics program may be included as part of the software 11 of the Tattoo Design Module 25.

In the tattoo field, once a tattoo design is selected, a tattoo stencil 43 is generally created or used to apply the design to a person's body. A tattoo stencil 43 is an outline of a tattoo design that is transferred to skin, and is then colored with tattoo ink. The stencil 43 acts as a guide for the tattoo artist. Some stencils are currently made by hand by the tattoo artist. Stencils may be created with thermal printers that print stencils 43 which can be transferred directly to the desired surface. Currently, in most cases, tattoo designs 37 are selected from paper or “hard copy” images. Once a tattoo design is selected, it is necessary for a tattoo artist to locate or make a stencil 43 for that tattoo design. This process can be time consuming and cumbersome. In addition, stencils 43 also may be made by hand (such as by hand tracing printed images onto carbon paper), another time consuming and inefficient process.

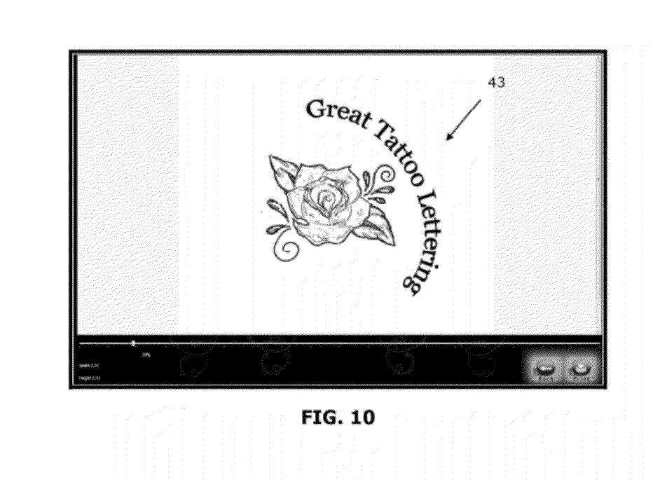

A novel aspect of the present invention is the automated and/or semi-automated creation of a stencil 43 based on a customer's tattoo design and/or text selection. The system of the present invention can be configured to generate a tattoo stencil 43 for use by a tattoo artist. The software 11 of the Tattoo Stencil Creation Module 26 of the present invention is configured to detect and/or plot the outline and shading elements of a given tattoo design in order to create a usable tattoo stencil 43. FIG. 9 is a representative screen or portion of a screen of the present system 10, showing a selected and user-selected/customized tattoo design 37 including text on the left portion of the screen, and a stencil 43 created by the system 10 based on the user selected/customized tattoo design and text shown on the right portion of the screen, in a side-by-side view. As part of the software 11 of the Tattoo Stencil Creation Module 26 configured to perform as a stencil 43 customizer and/or editor, a slider may be provided for adjusting the stencil 43 image, such as by increasing or decreasing the thickness and/or depth and/or detail and/or transparency of the stencil 43 image. FIG. 9 shows a stencil 43 that is being created and/or adjusted, such as for printing. The present system 10 may include a thermal printer 45 for printing the stencil 43 image, so that the stencil 43 image can be applied directly to a customer's 16 body. Thus, the present invention eliminates the need for a tattoo artist to either locate or make a stencil 43, both time-consuming tasks. FIG. 10 shows a representative screen of the Tattoo Stencil Creation Module 26 that may be shown once a tattoo design and stencil 43 are finalized.

The software of the Tattoo Stencil Creation Module 26 is preferably configured to take any full color image or design of any kind, and create an outline drawing for use as a stencil 43. This may be achieved, by way of example, through software (such as, for example, through software having functionality similar to, for example, the Photoshop®, Adobe® Streamline®, or CorelDRAW® or CAD software programs or other similar or known software programs in the field of, for example, graphics and/or images), having, for example, “line detection,” “find edges,” “auto-tracing,” “image contours,” “vectoring,” “auto-tracing,” “tracing,” “edge detection” or “outline” functionality (as shown by way of example in FIG. 9), or other similar functionality, whereby the software detects the outlines of an image or design (including any text), and generates a lined image based on the original image that only shows the outlines such as needed for a tattoo stencil. This is preferably performed automatically by the software of the Tattoo Stencil Creation Module 26, whereby when an image or design is loaded into the software, and the software automatically creates the stencil 43.

In addition, the Tattoo Design Module 25 and/or the Tattoo Stencil Creation Module 26 can also generate, such as via a printer, or on-screen, the full color version of the selected design. A tattoo artist can then use this design as a guide while applying a tattoo. Therefore, the system supplies not only the stencil, but also an image that may be helpful is ensuring the accuracy of the design as selected by a customer.

At a point in the process, a customer 16 may find it necessary to interact with an administrator 34 (or any person having administrative privileges), who will assist in completing the body design transaction, such as through the software 11 of the Administration Module 28. It is further contemplated that the Administration Module 28 may include specialized profile files (such as Administrative Profiles 86 for those having administrative privileges) which may be stored in an Administrative Database 80. The Administrative Profiles 86 may be accessed by administrators 34, in the same manner as customers can access Customer Profiles 35, described herein. However, Administrator Profiles will have additional administrative privileges, and an administrator will have access to the Administration Module 28.

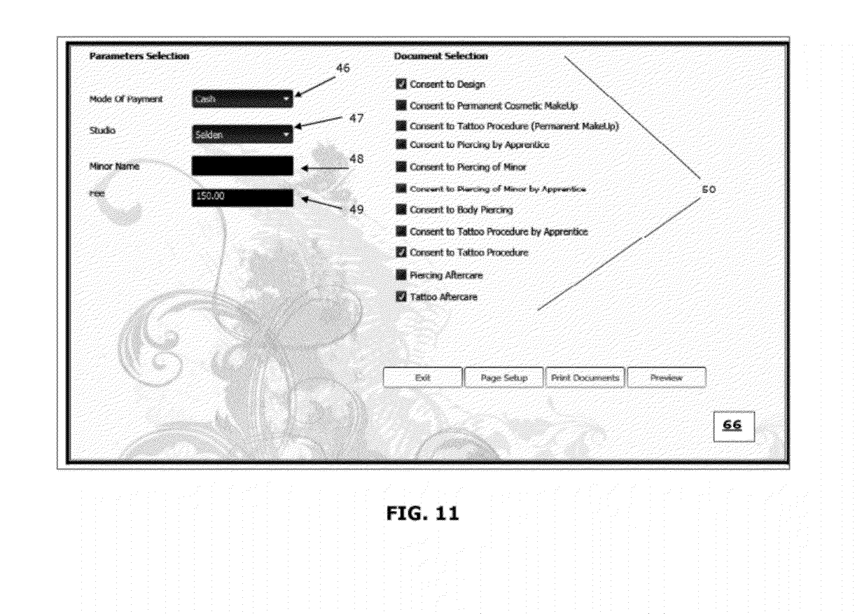

As shown in FIG. 11, a representative display screen 66 of the Administration Module 28, a drop-down selection menu may provide for the option of selection the payment type (mode of payment menu 46). Another drop-down selection menu allows the selection of a tattoo shop 13 location, for example, where a tattoo shop 13 is one of a chain or multiple locations (location menu 47). A field may be provided if the customer 16 is a minor, which may require permission from a parent or guardian (minor field 48). The fee for the tattooing (or piercing) services also may be provided in a field (the fee field 49). In order to finalize a transaction and/or provide information to the customer 16, various informational documents 50 may be selected and printed, as shown in FIG. 11.

As shown in FIG. 23, the software 11 of the Informational Document Module 29 may be included as part of the Administration Module 28, since the provision of informational documents 50 is an administrative function. A tattoo shop 13 administrator 34 is able to access the Informational Document Module 29 and customize the documents that are to be printed for the customer 16 (such as documents for signature to approve a tattoo design and to execute any legal or form documents needed to apply a tattoo to the customer) and/or for tattoo shop 13 record-keeping. FIG. 11 shows a screen displaying potential selections of illustrative documents for printing that relate to the tattoo shop 13 business and compliance with laws and/or regulations, such as consent forms, aftercare forms (directions to clients regarding proper care for tattoos and piercings), and any other available documents. The system 10 is preferably designed to be capable of automatically populating various fields in the documents, such as with the customer's 16 name, address, payment information, pricing, etc. This information may be drawn from various databases associated with the system 10.

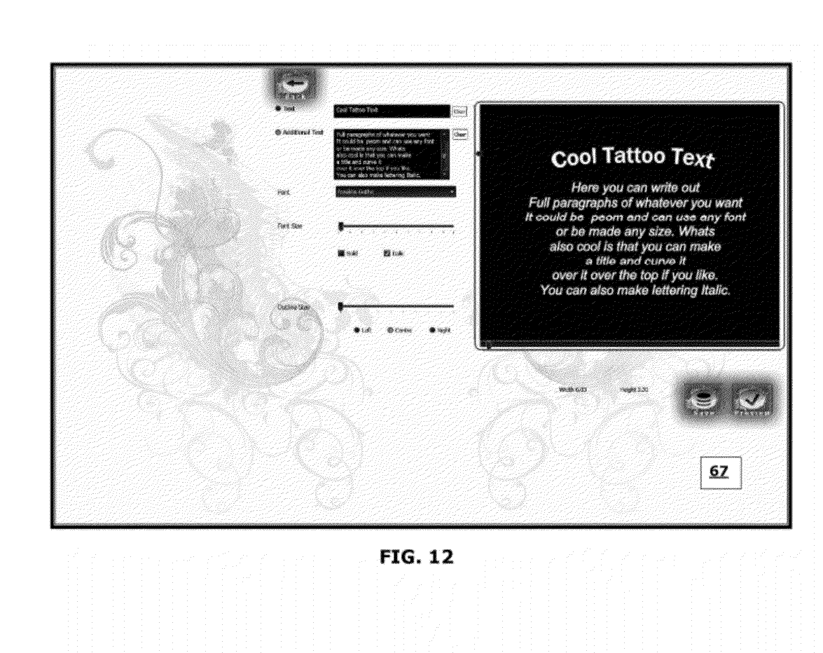

FIG. 12 shows a representative display screen 67 of the Tattoo Design Module 25 of the system 10 showing a “text only” tattoo design. A customer 16 may seek to have names, poems, saying, quotes, etc., rather than a graphical image. The system 10 provides for complete customizable text entry and editing, such as text size, line breaks, font type, font size, word location, text positioning, outlining, shading, etc. A stencil 43 may then be created using the Tattoo Stencil Creation Module 26, as described herein. All functionality of a word processing or graphics program such as, for example, Microsoft Word®, WordPerfect®, Photoshop®, Adobe® Streamline®, CorelDraw®, or similar programs, in creating, customizing, editing and checking (such as spell-checking or checking grammar, punctuation and/or capitalization, etc.) text, are preferably included as part of the Tattoo Design Module 25, so that a customer 16 has many design options. Presently, in the field of tattooing, transferring a line or entire paragraph of text to a customer's body is both time-consuming and tedious. For example, transferring a paragraph free-hand to a consumer's body can take up to an hour. Using the Tattoo Stencil Creation Module 26 of the present invention to transfer text to a customer's body saves time and is a simpler system.

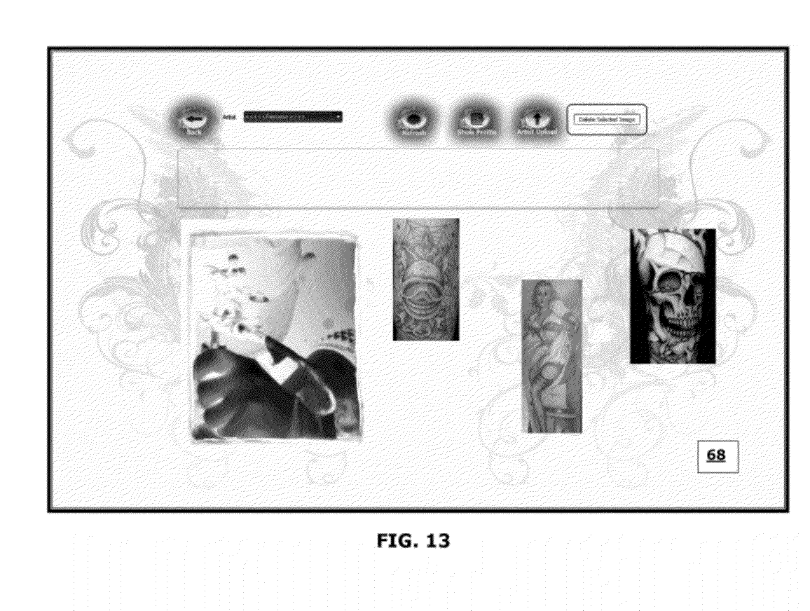

Another aspect of the present invention is the capability of displaying artist portfolios, that is, a collection or gallery 52 of work by the tattoo and/or body piercing artists performing work at a particular tattoo shop 13. FIG. 13 is a representative display screen 68 of the Artist Portfolio Module 27, where a customer 16 can select the work of various artists using menu selections, a see a collection of the artist's work. Administrators 34 also can access a separate part of the system 10 for uploading images to display in a particular artist gallery. The artist gallery allows a tattoo shop 13 to display artists' work, and allows a customer 16 to view various designs, images, prior customers, or similar images, in a convenient manner. Tattoo artists may also update their own portfolios and galleries using the system of the present invention, and the portfolio will automatically be updated for any related tattoo shops that are connected via a network using the system of the present invention.

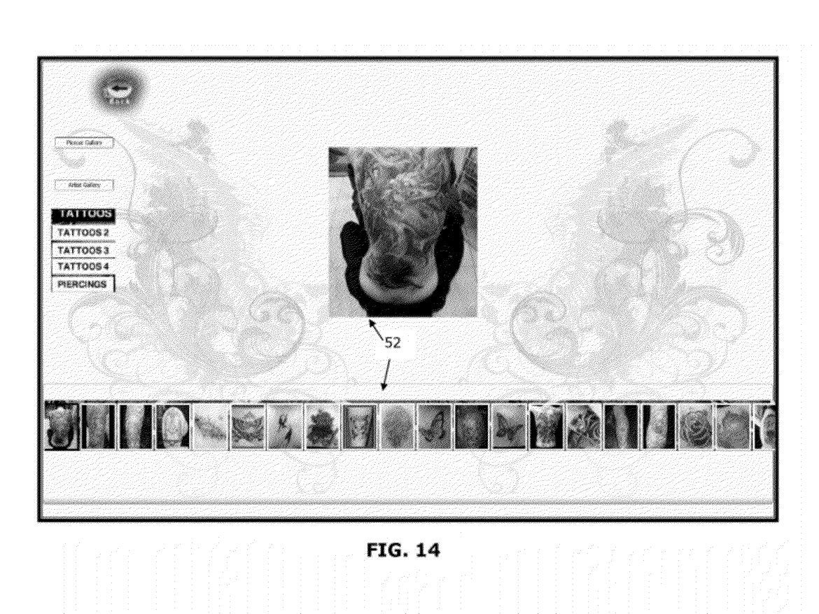

The system 10 also can be set to display preselected images in a gallery 52 as part of the Gallery Module 79, as shown by FIG. 14, which shows a representative display screen of an image gallery. This screen may show a random slideshow or other display of tattoos and piercings done at the shop or a related shop.

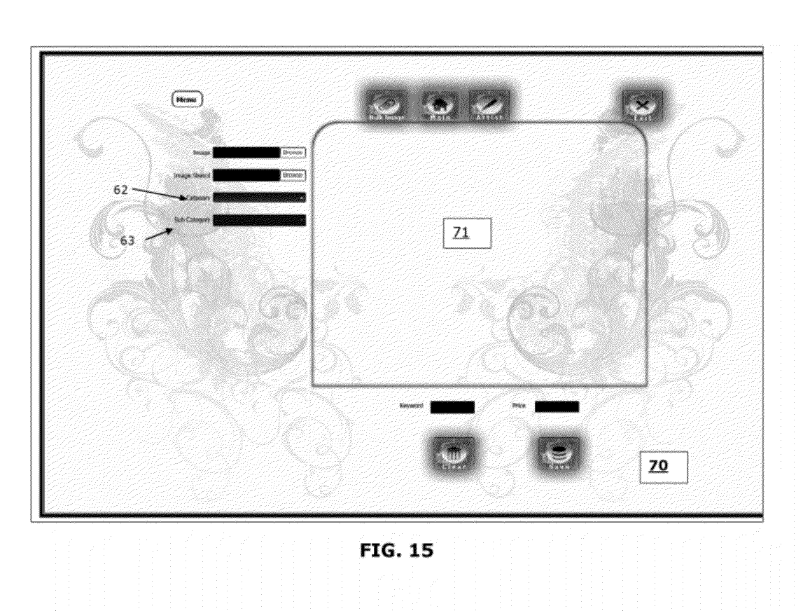

Representative screens of the Administration Module 28 of the system 10 are also shown in FIGS. 15-22, where an administrator 34 (person with administrative privileges) can, for example, access the system 10 and perform various administrative functions, such as profile management, pricing management, manage images, design and galleries, upload files (or any kind), manage documents, manage hardware associated with the system 10, adjust work schedules, perform calendaring tasks, or other related business functions associated with a tattoo shop 13. It is contemplated that the system will include software having features similar to, or that may be integrated with, for example, Microsoft® Outlook®, Google® Calendar®, or other calendaring, or time-management programs. The Administration Module 28 may comprise Administration Database 80 comprising files accessed, used, or otherwise part of the Administration Module 28.

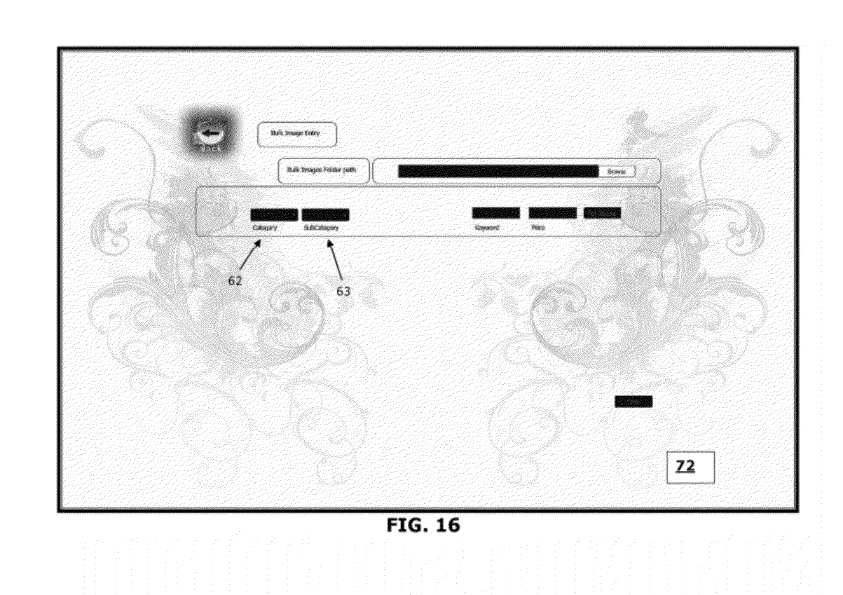

In particular, FIG. 15 shows a representative display screen 70 of a part of the Administration Module 28 where an administrator 34 can upload tattoo designs 37, and assign them to a particular category 62 and/or sub-category 63. A window 71 shows a selected tattoo design. In addition, a stencil 43 image can be uploaded, although, as discussed, the system 10 can create a stencil 43 for any particular design generated or captured using the system 10. In addition, “keywords” or “tags” can be entered in the appropriate field, so that the image is accessible on search. FIG. 16 shows a representative display screen 72 showing a part of the Administration Module 28 where an administrator 34 can “bulk upload” a group of images from, for example, a folder on a computer 12 containing the images, a database of images, etc. Using this feature, the administrator can categorize or tag the images with keywords at once, rather than categorizing or tagging individual images one at a time.

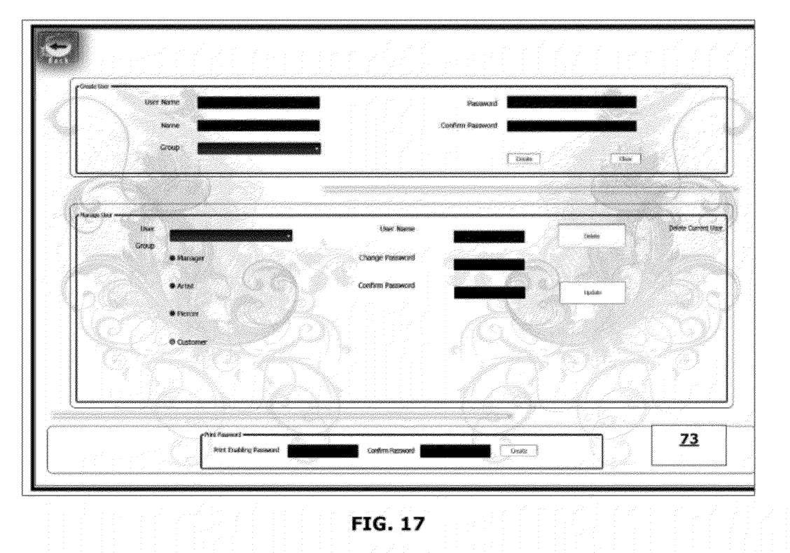

FIG. 17 shows a representative display screen 73 of the Administration Module 28 where an administrator 34 can set user permissions and privileges. As shown in FIG. 17, user names, passwords, groups (such as piercer, tattoo artist, customer 16, manager), print permissions, etc., can be entered or managed by this screen.

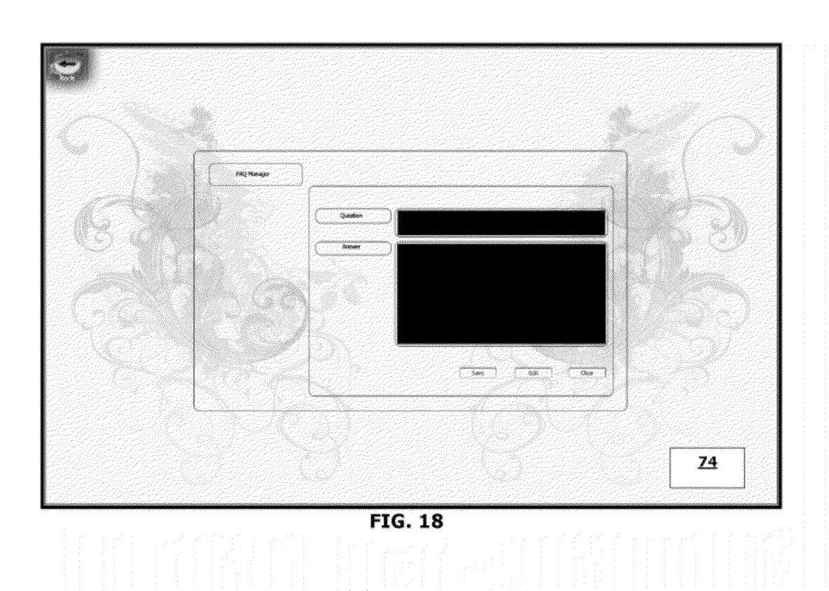

The system 10 also can provide responses to “Frequently Asked Questions” or “FAQs” a customer 16 may have. FIG. 18 shows a representative display FAQ Manager screen 74 of an FAQ Module 30 providing fields where an administrator 34 can enter FAQs, and type in responses. The FAQs are accessible throughout the system 10, and can be accessed from various screens through a link, button or menu selection. FAQs and/or files representing the same and the pertinent responses may be stored by the system in a FAQ Database 81. For example, one FAQ might be, “How do I care for my piercing to avoid infection?” The administrator 34 can input a response that can be accessed throughout the system, and may be printed by the customer. The FAQs, stored in the FAQ Database 81 and responses are searchable by keyword, natural, Boolean searching, Google search, or any other appropriate means. A person with administrator 34 privileges may access, modify, update, add, delete, or otherwise revise FAQ's in the in the database.

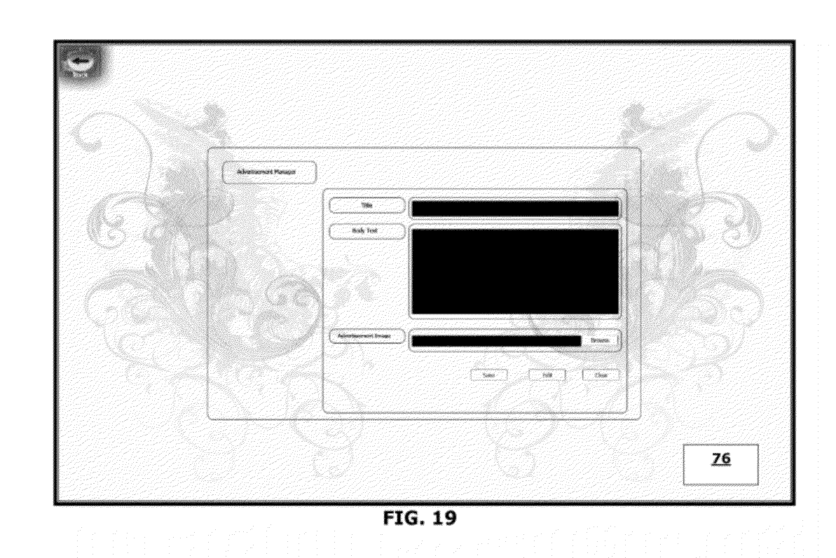

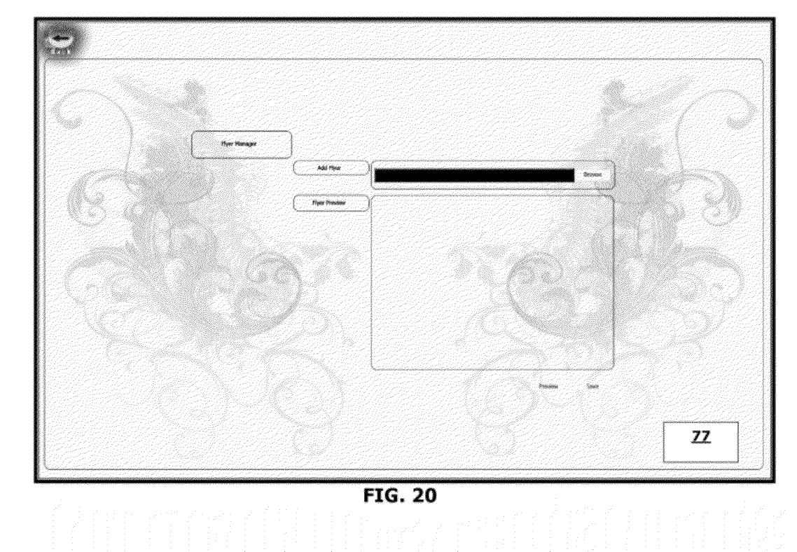

The system 10 also may be designed to provide advertisements, such as banner ads, on various screens throughout the system 10, using an Advertising Module 31. The Advertising Module 31 is configured so that ads in the system 10 can cycle, whereby refreshing a browser or changing screens will bring up on of the ads in the system 10. FIG. 19 shows a representative display of an Advertising Manager screen 76 of the Advertising Module 31 where advertising text and/or images can be entered by an administrator 34. FIG. 20 shows a representative display Flyer Management screen 77 of the Advertising Module 31 where a file of a complete advertising flyer can be uploaded for display to a customer 16 using the system 10.

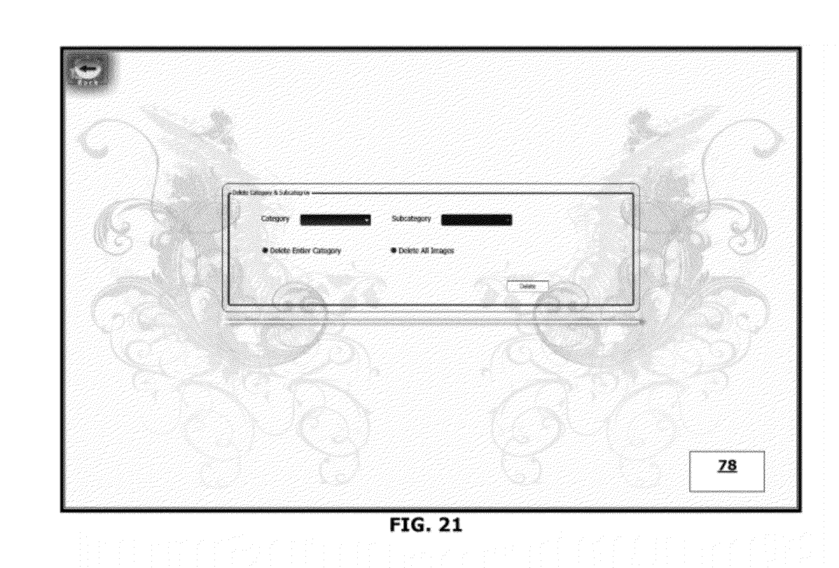

FIG. 21 shows a representative display screen 78 of the Administration Module 28 where an administrator 34 can manage tattoo designs 37 in the system 10, or delete entire categories of images.

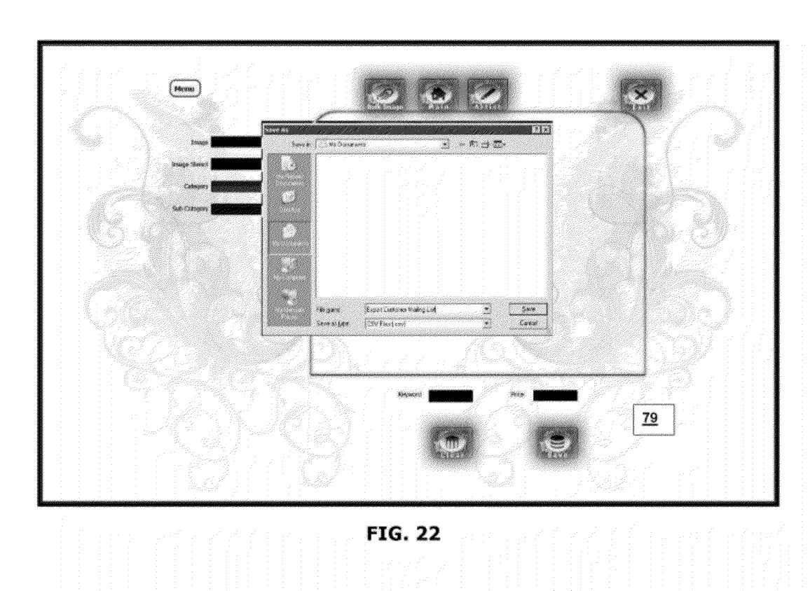

The creation of a Customer Profile 35 for each customer 16 provides a database of customer 16 information that a tattoo shop 13 can use for various advertising, marketing, and tracking purposes. Mailing lists may be compiled for mail or e-mail. FIG. 22 shows a representative display screen 79 of the Administration Module 28 showing an administrator 34 exporting a file containing customer 16 mailing list compiled by the system 10. As shown in FIG. 22, the customer mailing list file is saved in “*.CSV” format, which is a format that may be used by other software programs, such as Microsoft® Outlook®, or another word processing or mail program. It is contemplated that various files of the system can be used or exported for use by other software programs, such as e-mail programs, graphics or photo programs, banking programs (e.g., Quicken®), or others. The system can also be configured so that files from other software programs or files in various computer formats may be imported into the system for use by the system.

As shown by FIG. 24, optional peripherals in communication with the system 10 include a stencil printer 45 (preferably, a thermal printer 45 adapted to print usable tattoo stencils 43), and an optional scanner 53. A customer 16 may bring a printed image into a tattoo shop 13 to be used as a design. Customers also may have original artwork (either in hard copy or digital form) they wish to use as the basis for a tattoo design. The system 10 is configured to permit scanning the image into the system 10, saving the image as a tattoo design, and having it added to the Customers Profile 35. In addition, the tattoo design may be added to the Tattoo Design Database 39. The system 10 also is configured to allow customers 16 to bring in files, artwork, images, or designs on any electronic and/or digital storage medium, such as a flash or “thumb” drive 42, and add the artwork, images, or designs to the Customer Profile 35 for use as a tattoo design in connection with the system 10.

It is also appreciated that a scanner 53 of the present system can be used to, for example, scan in a driver's license or identification (e.g., passport, proof of age) of a user, in order to obtain, collect and/or save the demographic or identification information needed to process the paper work so that the customer can obtain a tattoo or body piercing. The identification information can be stored by the system, for example, as part of the Informational Document Module 29 or Legal Module 200 (described in greater detail herein).

In addition, the system may include Blue Tooth® or Wifi capabilities, whereby a consumer can access and communicate with the system via a “tablet” device (such as an iPad®), or a cell phone. The consumer can access the system via “apps” on such devices, login to the system, and perform any functions associated with the system, including, but not limited to, uploading images.

Often, identification such as a driver's license is required in order to receive a tattoo or body piercing. In an embodiment of the present invention, an item of identification such as a driver's license or other form of ID can be scanned into the system using the scanner 53, and associated or otherwise stored in that customer's Customer Profile 35. In this manner, tattoo shop employees can check a customer against a reference photo ID in the system.

The field of tattooing and body piercing can be time consuming for the artists and piercers. Much time is spent and lost in assisting customers 16 with selecting images, locating stencils 43, providing the necessary paper work, and other aspects of the business and services of a tattoo shop 13 that require personal attention. The system 10 of the present invention provides a way to conduct these services in an efficient and effective manner, and free up artist time to provide more tattooing and piercing services.

Customers also benefit from the system 10 of the present invention. Customers can browse, select, customize, and save designs to his/her Customer Profile 35. The Customer Profile 35 is created and stored by the software 11 that can be accessed either remotely, or at a later time. In this manner, a customer 16 has a recorded history of their interactions with the system 10, including tattoo designs 37 previously browsed, tattoo designs 37 previously obtained, and customized work saved but not yet obtained.

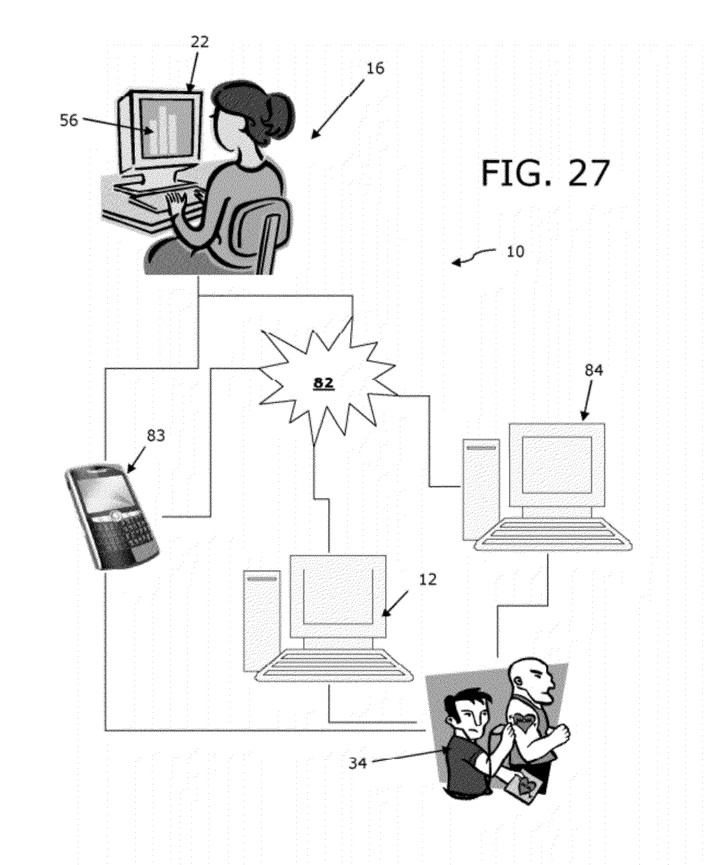

In one embodiment of the invention, an Internet web-based platform is provided for accessing the Customer Profile 35 and the system 10. As shown in FIG. 27, a customer 16 can access a website 56 through a computer or computers 22 connected to the Internet 82 through a web browser, and connect with a server or other computer 84 of the system 10 and the customer's Customer Profile 35 remotely. The customer 16 can then use the system as described, for example, reviewing, selecting, and customizing tattoo designs 37 or body jewelry designs, and save designs to their Customer Profile 35. A customer 16 can perform any of the operations described herein remotely, such as updating their Customer Profile 35, viewing the tattoo design database, editing text, and saving files to their profile. When a customer 16 then goes to a tattoo shop 13, they can access their Customer Profile 35. Alternately, the customer 16 can e-mail a selected design to the tattoo shop prior to going to the shop. A customer 16 also can schedule an appointment with a tattoo artist using an included calendaring program offered on the website. It is also contemplated that the networked system 10 can be accessed via a mobile phone 83, and a customer 16 can access their profile and interact with the system 10 in that manner as well. This may be through an “app” on a smartphone, for example. In addition, as shown in FIG. 27, an administrator 34 can also log into the system 10 via such an internet connection or mobile phone. In addition, the system can also be configured to allow an administrator 34 to monitor a customer's 16 interaction with the system, and can, for example, provide online “real time” responses to questions or otherwise interact such as through a “Helpline” chat or instant messenger function.

The present system may interconnect various tattoo shops 13, so that the tattoo shops can share system files, databases, and other components, and in order to provide for automatic and/or efficient updating of the system for more than one tattoo shop 13. Currently, in order to update the tattoo design options in a tattoo shop, for example, the tattoo shop staff must rely on what is termed in the industry as “flash.” Tattoo “flash” are sheets of paper showing illustrations or drawings of tattoo designs for the use of creating tattoos. Tattoo shops must hang multiple tattoo flash pages around the tattoo shop, or provide the tattoo shop flash pages in a rack or book of some kind, so that customers can review the tattoo flash. However, tattoo flash pages must be updated. This means, using the known manner of hard copy tattoo flash, the tattoo shop employees must physically replace the tattoo flash and/or hang new tattoo flash each time they wish to update the designs offered by a particular tattoo shop.

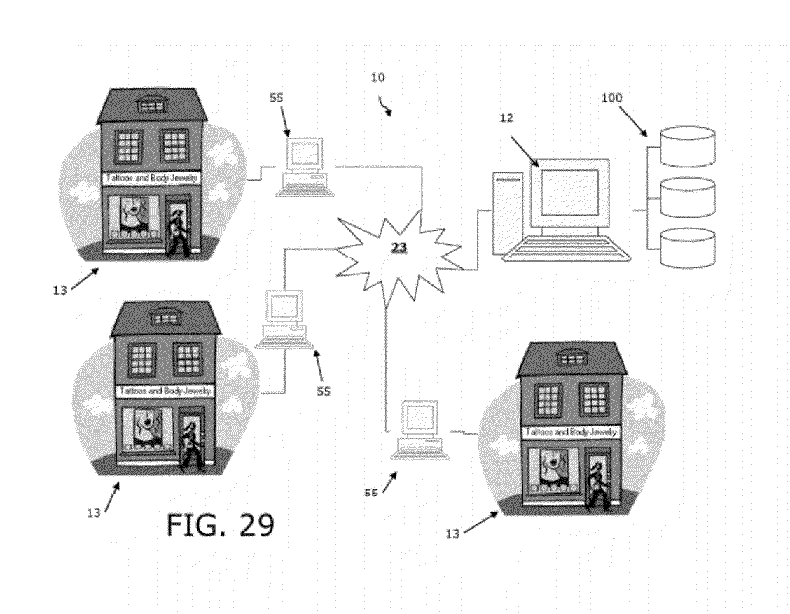

As shown schematically in FIG. 29, tattoo shops 13 in, for example, a chain, or tattoo shops 13 sharing information via computers of the system in communication, can all log into and be interconnected (such as through network 23) with the system 10 and/or system software 11 in order to, for example, share tattoo designs and/or photographs of body jewelry and/or other system files or data. When updates of, for example, new designs are supplied to the system 10, all tattoo shops 13 having access to the system 10 and various databases will automatically receive the updates. This greatly simplifies the process of updating the tattoo designs and/or body jewelry offerings in multiple shops. A representative computer 12 of the system 10 is shown in FIG. 29, and the software, and all necessary modules, files and/or databases of the system are represented as 100. Representative client computers 55, or computers connected to the system via a website 56, also are shown in FIG. 29. Modifying, adding, and/or deleting designs or artist portfolio pictures will only have to be done once in the system 10, and all tattoo shops 13 accessing the same system 10 will have access to the updates. Previously, if an owner owned four tattoo shops, the flash would have to be updated in each of the four tattoo shops individually. With the present system 10, the updating is essentially simultaneous in all locations at once. Also, all system files can be updated from a central location, and all connected system computers and/or software could be updated automatically.

Moreover, opening a new tattoo shop 13 is greatly simplified with the present invention. The new tattoo shop 13 can set up computers and other hardware for accessing the system, and access the system 10, going “live” right away.

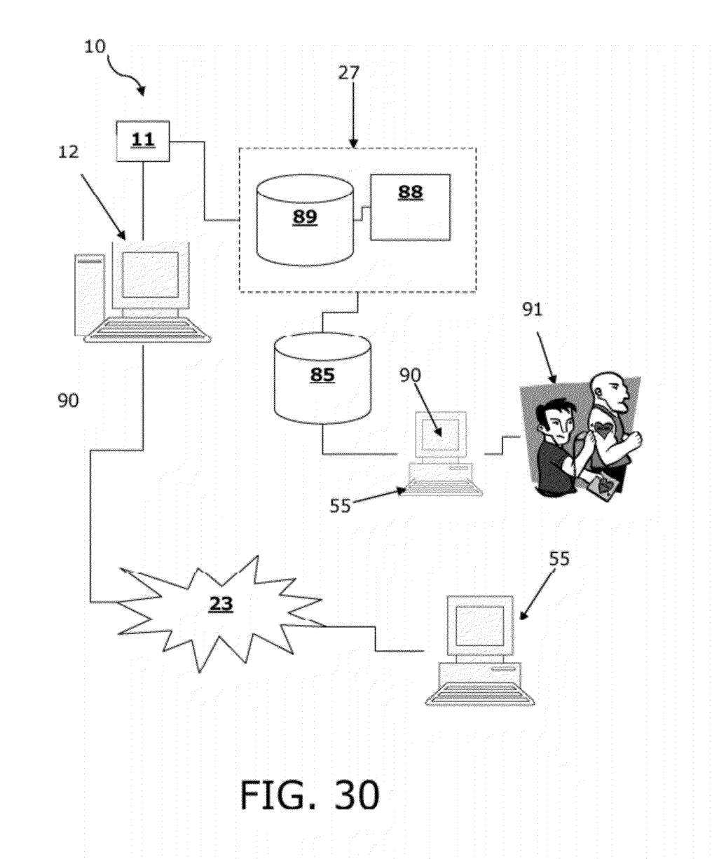

The accounts and/or profiles that are set up in the system for administrators, tattoo artists, and body piercers (Artist Profiles 88, which may be stored of or otherwise part of the Artist Portfolio Module) may have additional attributes and functionality, and may be stored in an Artist Profile Database 89 (which may be stored of or otherwise part of the Artist Portfolio Module), as shown in FIG. 30. Artist Profiles 88 may be created having expanded permissions for use of or access to components of the system 10. For example, an artist or piercer (shown in FIG. 30 for illustration as 91) working in a tattoo shop can login to his/her Artist Profile 88 and add, delete, or change tattoo design, or body jewelry designs, or photographs, or other images in the system. In this way, a tattoo shop administrator or manager does not have to devote time to maintaining or updating galleries. In addition, an artist or piercer 91 can take a picture of a tattoo or piercing as soon as it is provided to a customer, and upload the photograph to the system for inclusion in a gallery for immediate display in a particular tattoo shop (such as on the tattoo shop's website), or in any tattoo shop connected via the system.

Using an Artist Update Module 85 of the present invention also will greatly simplify the task of updating, organizing, and/or modifying tattoo flash or other designs, or body jewelry designs offered by a tattoo shop. As shown diagrammatically in FIG. 30, the Artist Update Module 85 comprises software of the system 10 configured to collect, sort, organize, share, and/or otherwise process tattoos designs 37 and/or photographs of body jewelry uploaded by the artists and piercers.

The present system 10 is designed to interconnect with tattoo shops 13 sharing access to the system 10. In this manner, each tattoo shop 13 website 90 can be automatically updated when the system 10 is updated. For example, the websites 90 will be in communication with the system 10 and the Artist Portfolio Module 27. The Artist Portfolio Module 27 may be updated by artists and body piercers 91 through, for example, the Artist Update Module 85. When an artist adds, for example, a new image of his/her tattoo work to the system for display in a gallery, all interconnected tattoo shop websites 90 will have their galleries automatically updated. Thus, the system 10 provides for an efficient way to continually keep websites fresh and with new content, without having to involve individual tattoo shop administrators, personnel or webmasters.

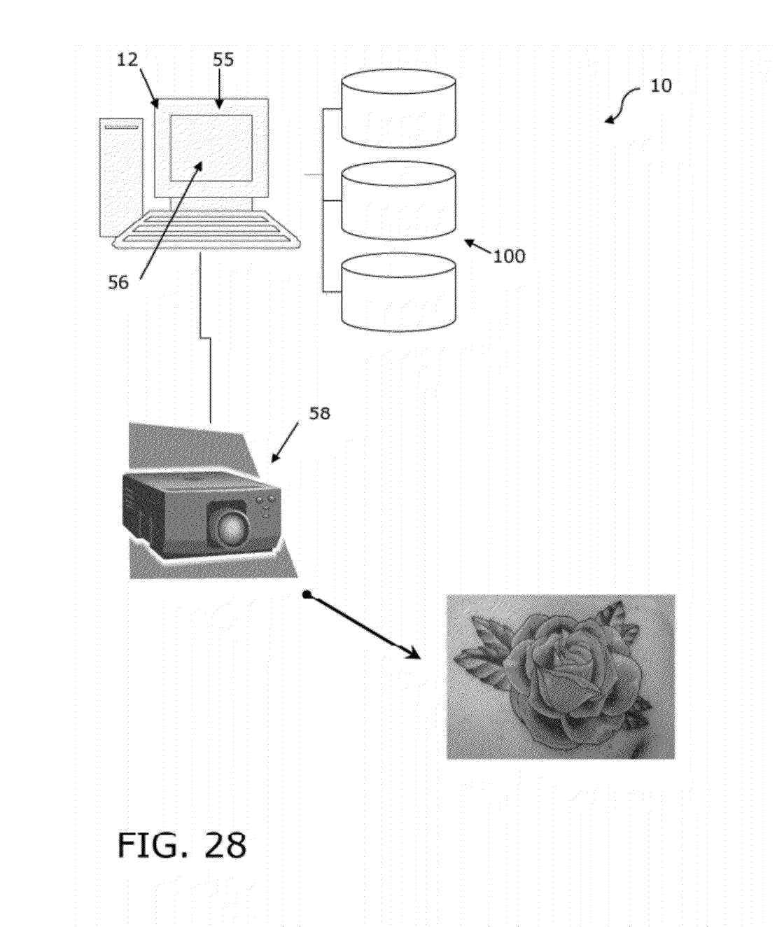

One issue a customer 16 may face when obtaining a tattoo or body piercing is that a customer 16 may not be able to envision or picture the design on their body before it is applied. In an embodiment of the present invention, as shown in FIG. 28, a projector 58 is provided as a component of and in communication with other components of the system 10. A representative computer 12 of the system 10 is shown in FIG. 28 in communication with the projector 58, and the software 11, including all necessary modules, files and databases is represented as 100. The projector 58 may be a hand held projector 58, or may be provided on a tripod or other holding and positioning structure. The projector 58 is adapted to project a selected tattoo design or selected jewelry for body piercing onto a person's skin. An example of a tattoo design projected onto a person's back and shoulder area is shown by way of illustration in FIG. 28. In this way, a customer 16 has an opportunity to review how a design will appear on their body when applied. The projector 58 may provide a full color projectable image to give the customer 16 a “real world” view of a proposed tattoo design. Thus, the system 10 provides for a means of “tattoo sampling,” without being invasive, never before seen in the tattooing field. It is appreciated that the computer 12 may be a client 55 computer or may be in communication with a remote computer of the system 10 and connected to the system 10 through a website 56, so that the computer 12 does not need to house all components of the software 11 of the system 10, which may be housed on the remote computer.

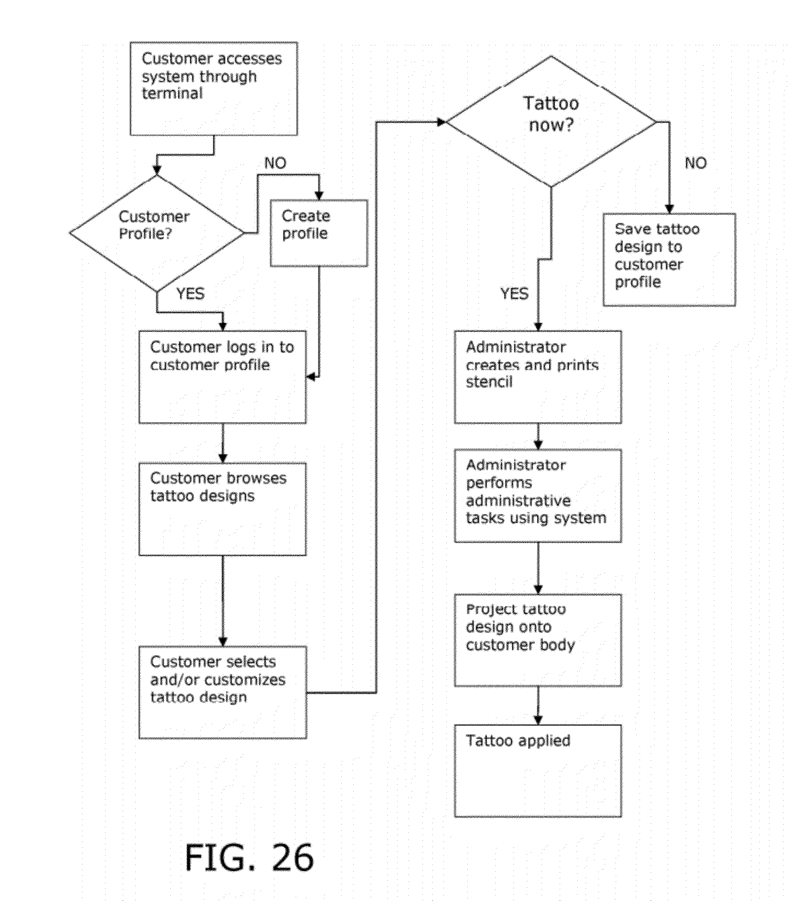

A flow chart of a customer's 16 and administrator's 34 interactions with and use of the system 10 is shown diagrammatically in FIG. 26. A customer 16 accesses the system 10 through either a terminal in a tattoo shop 13, or alternately, through their own computer 12 via the internet. The customer 16 first encounters a Login Screen 33, where they can create either a Customer Profile 35 with the software 11 of the Customer Profile Module 24, or login to an existing Customer Profile 35 and access their Customer Profile via the software 11 of the Customer Profile Module 24 by entering a previously created user name and password.

Customers 16 can log into his/her Customer Profile 35, and can perform various tasks via the software 11 of the Customer Profile Module 24, such as review prior history, manage demographic information (name, address, e-mail contact, mailing preferences, etc.). As shown in FIG. 26, a customer 16 may wish to browse tattoo designs 37 via the software 11 of the Tattoo Design Module 25. Once a customer 16 selects a tattoo design, the customer 16 can save the design to their Customer Profile, and the Customer Profile will be associated with that design. The customer 16 can either continue using the system 10, or attend the tattoo shop 13 at a future time to get the selected tattoo design.

If proceeding to getting the tattoo design, in a preferred embodiment, the customer 16 would interact with an administrator 34 (or person with administrative privileges) to discuss finalizing the tattoo transaction. The administrator 34 (or person with administrative privileges) creates a tattoo stencil 43 via the Tattoo Stencil Creation Module 26. The administrator 34 also may use the software 11 of the Administration Module 28 to perform administrative tasks, such as, for example, making and/or finalizing billing arrangements, and providing informational documents 50 (including documents required by law for obtaining a tattoo, such as consent forms) via the Informational Document Module 29. The Informational Document Module 29 may populate the forms automatically, using the information from the Customer Profile Module 24. The customer may wish to see a preview of the selected design on their body using the projector 58 of the system. If accepted, once the necessary documents 50 have been printed and signed, the customer 16 is ready to receive the selected tattoo design 37. It should be appreciated that not every activity or step shown in FIG. 26 is necessary for every interaction with the system, and that any combination of activities or steps whereby a customer and administrator interact with the system are considered to be within the scope of the invention.

It is appreciated that the present system 10 can function effectively and efficiently in the area of body piercings as well as tattooing. Thus a customer 16 seeking a body piercing using the system 10 of the present invention may access the system 10 via a Customer Profile Module, as previously described. The customer 16 may browse available body jewelry designs via the software 11 of the Body Jewelry Module 32. Body jewelry designs will be displayed similarly to the tattoo designs 37 as described herein. Thus, a customer can search for body jewelry through keywords or categories and sub-categories. A selected piece of body jewelry may be saved to, or otherwise associated with, the customer's Customer Profile 35. If proceeding with obtaining the selected piece of body jewelry, the customer 16 will then interact with an administrator 34 to finalize the transaction using the system 10. The customer 16 may preview the body jewelry on his/her body using the projector 58 of the system 10.

The present system additionally provides for a look and feel of a tattoo shop that is a departure and improvement from historic tattoo shops. For example, as shown in FIG. 25, rather than shop walls filled with tattoo “flash” or images, the tattoo shop using a system of the present invention can have a very “clean,” modern and fresh look.

Another aspect of an embodiment of the system of the present invention is the incorporation of a Legal Module 200. The Legal Documents Module 200 may alternatively be part of the Informational Documents Module 29, or may be a separate module altogether, and is in communication with the other parts of the system for access and use by the system. The Legal Module 200 (an example shown schematically in FIG. 23) contains software and/or data and/or files relating to any legal documents, information or notices needed for a customer who is getting a tattoo or body piercing. For example, certain jurisdictions may require that an “informed consent” type of document be executed by a customer before a tattoo or body piercing can be applied. Alternately, it may be necessary for a customer to check the accuracy of a design and/or text selected for application as a tattoo. The Legal Design Module 200 is configured to provide for the documentation needed to address these or similar issues, or to generate any documents needed by a tattoo shop or administrator 34 to provide legal documentation for a tattoo or body piercing.

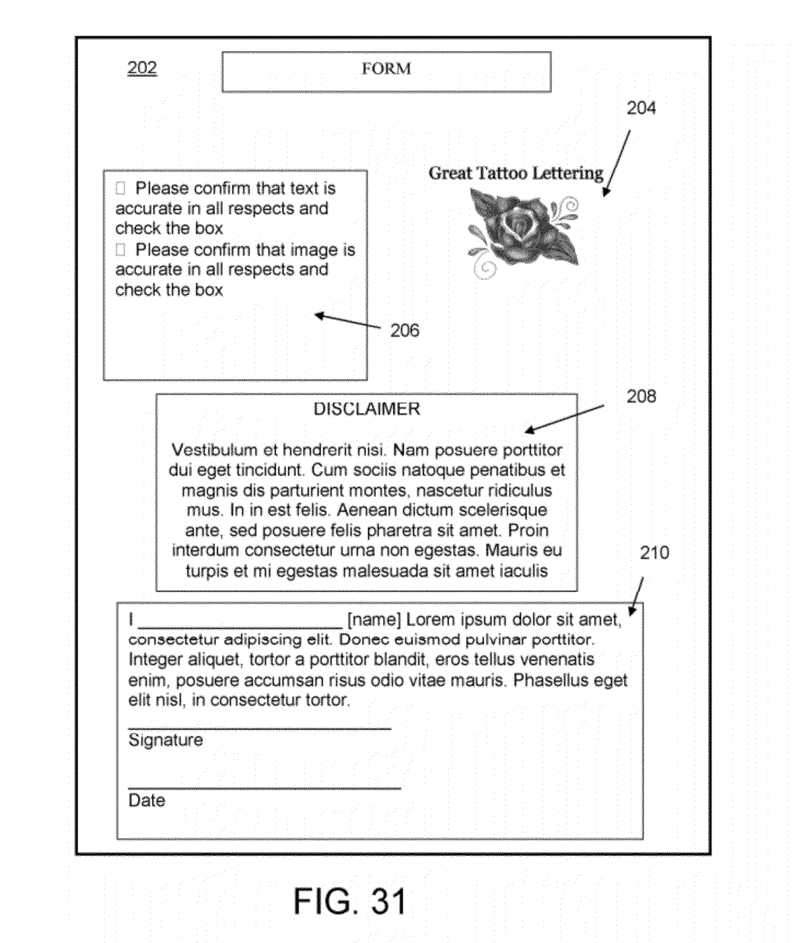

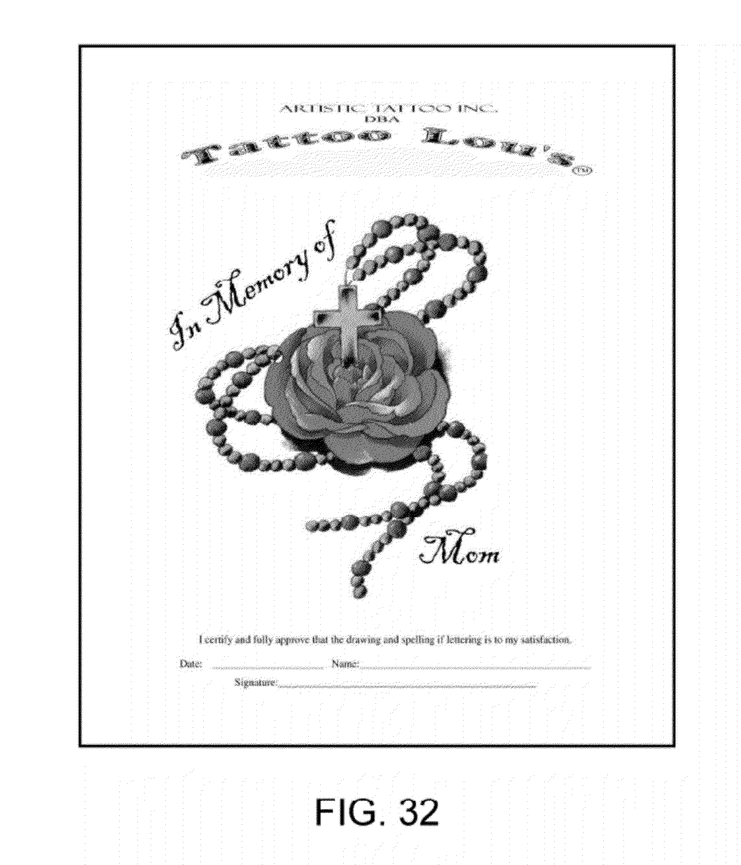

The system may, by accessing or otherwise utilizing the Informational Documents Module 29 and/or the Legal Module 200, generate a form (either electronically such as on-screen or via a printer), such as the illustrative form 202 shown in FIG. 31, or the supplemental illustrative form page shown in FIG. 32. The illustrative form 202 includes the image and/or text 204 selected by the customer for a tattoo, a “check-box” 206 so that the customer can verify the accuracy of the tattoo and any text of the tattoo (this is significant from a practical and legal standpoint, particularly with, for example, tattoo spelling issues or errors), an example of a “DISCLAIMER” 208 that may be created by a tattoo shop or required by pertinent laws, and an addition signature section 210, including any other language desired by a tattoo shop or required by law, for signing and dating by a customer. Accordingly, the system provides for a documentation that is verified by a customer. This form documentation may be either in hard copy (which may also be scanned into the system), or may be an electronic form that is filled in electronically (e.g., on screen, on-line, via notebook, computer or cell phone). The form documentation may be maintained electronically by the system such as via files in the Informational Documents Module 29 and/or the Legal Module 200, and can be printed for review or inspection at any selected time.

An optional electronic signature pad 212 can be used with the system. That electronic signature pad 212, which is in communication with the computers of the system, can be used to sign off on, for example, the form 202. The signature is electronically stored with the electronic customer records. Currently, a tattoo shop must generally save hard copies of signed records and/or documents, which is both inconvenient and wastes space. Using the system of the invention, such records and/or documents may be stored and maintained electronically.

Having thus described in detail embodiments of the present invention, it is to be appreciated and will be apparent to those skilled in the art that many physical changes, only a few of which are exemplified in the detailed description of the invention, could be made without altering the inventive concepts and principles embodied therein. It is also to be appreciated that numerous embodiments incorporating only part of the preferred embodiment are possible which do not alter, with respect to those parts, the inventive concepts and principles embodied therein. The present embodiment and optional configurations are therefore to be considered in all respects as illustrative and/or illustrative and not restrictive, the scope of the invention being indicated by the appended claims rather than by the foregoing description, and all alternate embodiments and changes to this embodiment which come within the meaning and range of equivalency of said claims are therefore to be embraced therein.

What is claimed is:

1. A body ornamentation design, customization and management system, comprising:
at least one computer, the at least one computer comprising software comprising: a customer profile module, a tattoo design module, a tattoo stencil creation module, and, an administration module.

2. The body ornamentation design, customization and management system according to claim 1, further comprising an artist portfolio module.

3. The body ornamentation design, customization and management system according to claim 1, further comprising an informational document module.

4. The body ornamentation design, customization and management system according to claim 3, further comprising a legal module.

5. The body ornamentation design, customization and management system according to claim 1, further comprising an FAQ module.

6. The body ornamentation design, customization and management system according to claim 1, further comprising an advertising module.

7. The body ornamentation design, customization and management system according to claim 1, further comprising a body jewelry module.

8. The body ornamentation design, customization and management system according to claim 1, further comprising an artist portfolio module.

9. The body ornamentation design, customization and management system according to claim 8, further comprising an artist update module.

10. The body ornamentation design, customization and management system according to claim 1, further comprising at least one scanner.

11. The body ornamentation design, customization and management system according to claim 1, further comprising at least one projector in communication with the computer.

12. The body ornamentation design, customization and management system according to claim 1, further comprising at least one second computer in communication with the first computer via a network, the at least one second computer configured to access the software of the first computer.

13. A method of providing a body ornamentation to a person utilizing at least one computer to a person, the at least one computer comprising or configured to access software comprising a customer profile module, a tattoo design module, a tattoo stencil creation module, and, an administration module, comprising the steps of:
a. obtaining customer information via the customer profile module;
b. storing the customer information in the customer profile module;
c. providing a selection of body ornamentation designs via the tattoo design module to the customer so that the customer can select a body ornamentation design for application to the person's body;
d. obtaining a selection of a body ornamentation design to be applied to the person's body;
e. storing the selection of a body ornamentation design to be applied to the person's body in the customer profile module;
f. accessing the customer profile module;
g. creating a stencil representing the body ornamentation design via the tattoo stencil creation module;
h. printing the tattoo design module via a printer;
i. applying the stencil to the person's body.

14. The method of claim 13, further comprising the step of generating documentation relating to the application of the body ornamentation design to the person's body via an informational document module, and printing the documentation via a printer.
